(19) United States
(12) Patent Application Publication
(10) Pub. No.: US 2005/0053311 A1
(43) Pub. Date: Mar. 10, 2005

(54) Non-integer scaling of bi-tonal files

(75) Inventor: John J. Burlingame, Camas, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/726,373

(22) Filed: Dec. 2, 2003

Related U.S. Application Data
(60) Provisional application No. 60/500,534, filed on Sep. 5, 2003.

(51) Int. Cl. G06K 9/32

(52) U.S. Cl. 382/298

(57) ABSTRACT

A method for non-integer scaling a bi-tonal image utilizing an interleaved blend of pixel-block image rotation(s), interspersed with a pair of rotation-separated, line-by-line, one-dimensional non-integer image expansions.

### CROSS REFERENCE TO RELATED APPLICATION

This application claims priority to U.S. Provisional Patent Application Ser. No. 60/500,534 covering an invention entitled “Non Integer Scaling of Printable Files”, filed Sep. 5, 2003. The inventorship is the same in that provisional application as it is in this application, and the entirety of that provisional patent application is hereby incorporated herein by reference.

### BACKGROUND AND SUMMARY OF THE INVENTION

This invention relates to digital image scaling, such as image scaling for printing, and in particular pertains to non-integer scaling of bi-tonal images (files).

While relatively quick, efficient and simple conventional approaches to integer scaling of various images, as for example, in preparation for re-scaled printing, are available, such as through the use of pre-done look-up tables, and the uses of various, quite satisfactory “integer-scaling-related” algorithms, non-integer scaling of bi-tonal images presents quite another situation. Speed and efficiently are usually not descriptions of such scaling which on the contrary, often requires tedious pixel-by-pixel processing.

The present invention offers a simple and easily implemented and practiced resolution to the non-integer scaling dilemma relating to bi-tonal images. Utilizing, in its preferred and best mode styles, a relatively straight-forward interleaved blend of pixel-block image rotation(s), and essentially a pair of rotation-separated, line-by-line, one-dimensional non-integer image expansions, non-integer, bi-tonal image scaling becomes a relatively quick and efficient operation, greatly improved over practices current in the prior art. Three different embodiments of the invention are presented herein, each of which involves (a) selecting a bi-tonal image file for non-integer scaling by a selected scaling factor, and (b) with regard to the selected image file, applying to it two one-dimensional non-integer line-by-line expansions based upon the selected scaling factor separated by a step involving orthogonal rotation of the image file.

The features and advantages of the invention will become more clearly evident and appreciated as the detailed description which follows below is read in conjunction with the accompanying drawings.

### DESCRIPTION OF THE DRAWINGS

FIG. 1 is a block/schematic illustration (stages (a)-(e), inclusive) of one preferred and best mode (systemic and methodologic) embodiment and manner of practicing the present invention designed to perform non-integer bi-tonal image scaling in which the scaled bi-tonal output image is intended to end up rotated 90° relative to the input image.

FIG. 2, in stages (a)-(e), inclusive, illustrates the operation of the form of the invention pictured in FIG. 1.

FIG. 3 is another block/schematic illustration (stages (a)-(f), inclusive) showing another preferred and best mode form (a modified form) of the invention designed to perform non-integer, bi-tonal image scaling in which the scaled bi-tonal output image is not to end up in a rotated condition.

FIG. 4, in stages (a)-(f), inclusive, illustrates the operation performed by the invention modification of FIG. 3.

FIG. 5 is yet a further block/schematic diagram (two stages, (a)-(e), inclusive, and [a]-[f], inclusive) showing still another preferred and best-mode style (another modified form) of the present invention which is designed especially to offer two, selectable options regarding whether or not the final non-integer scaled bi-tonal output image is to be rotated.

FIG. 6, in two set of stages (a)-(e), inclusive, and [a]-[f], inclusive, illustrates the two “scaling routes” of performance offered by the invention arrangement of FIG. 5.

### DETAILED DESCRIPTION OF THE INVENTION

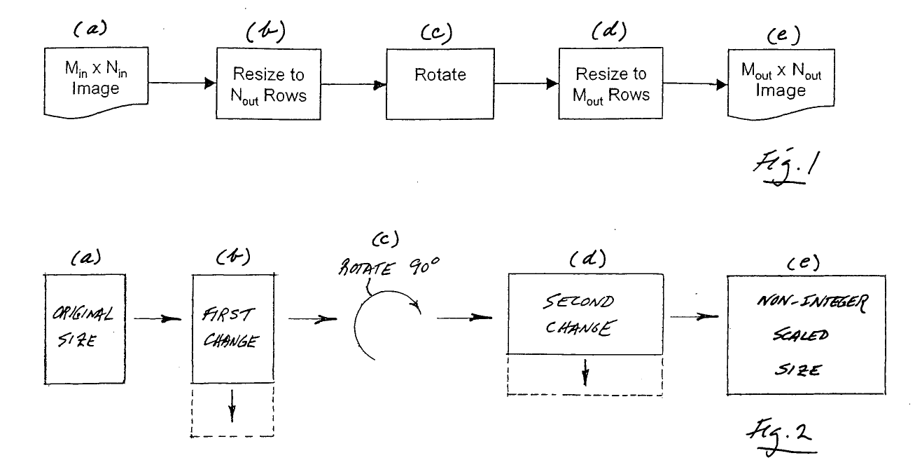

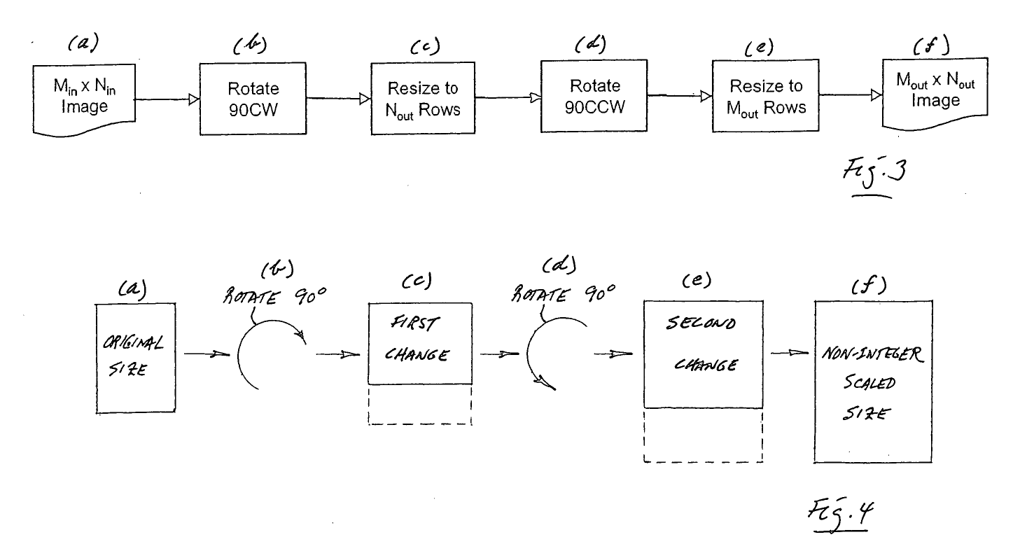

Turning now to the drawings, and beginning with FIGS. 1 and 2, these two figures illustrate implementation and practice of the invention in a manner dedicated to non-integer rescaling of an original bi-tonal image, (a) in FIGS. 1 and 2, wherein the final bi-tonal output image, (e) in both figures, is to be rotated 90°. An original bi-tonal image having a defined original size is described by an appropriate created digital data file (a) which has an M_{Input}×N_{Input}, generally “portrait”-configuration presentation (just for illustration purposes) which is to be re-scaled (re-sized) proportionately by the representative, non-integer factor of 1.5, and to be output as a 90°-clockwise (CW)-rotated, larger, bi-tonal image (e). The CW rotation direction is also selected just for illustration purposes.

Re-scaling, in accordance with this form of the invention, begins with the application of a conventional line-by-line, one-dimensional, image expansion (resizing), (b) in FIG. 1, implemented, for example, by use of the well-known Bresenham algorithm, to generate a first, single lateral expansion, (b) in FIG. 2, by the factor 1.5. This is followed, (c) in FIG. 1, by the application of a conventional pixel-block rotation algorithm to produce, here, a 90° CW rotation, (c) in FIG. 2, of this first expansion phase of the now-being-rescaled original image file.

Next, another application, (d) in FIG. 1, of the Bresenham algorithm is implemented to produce a second, one-dimensional expansion (resizing), (d) in FIG. 2, of the image file, which second expansion produces the desired 90° CW-rotated, 1.5-factor-enlarged output bi-tonal image, M_{Input}×N_{Output} with a generally “landscape” configuration, (e) in FIGS. 1 and 2.

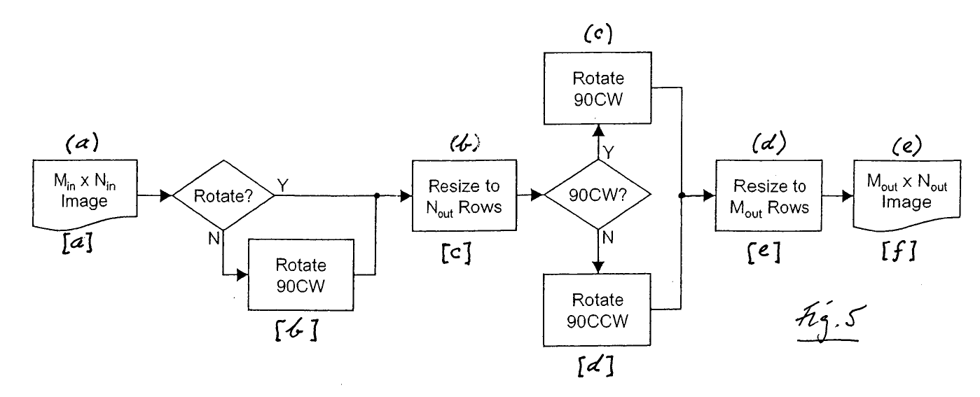

FIGS. 3 and 4, now addressed, illustrate a modified, but also “dedicated” form of the invention, wherein, using the same 1.5-scaling-factor discussed above, the same original bi-tonal image file, (a) here in FIGS. 3 and 4, is to be enlarged to a non-rotated bi-tonal output image, (f) in FIGS. 3 and 4. Again, a conventional pixel-block rotation is performed, in this case twice, in steps (b) and (d) in FIGS. 3 and 4, alternated/interleaved with two “spaced” applications of the Bresenham unidirectional expansion algorithm, (c) and (e) in FIG. 3. FIG. 4, of course, pictures what is taking place in FIG. 3 in the same manner that FIG. 2 pictures what is occurring in the steps illustrated in FIG. 1.

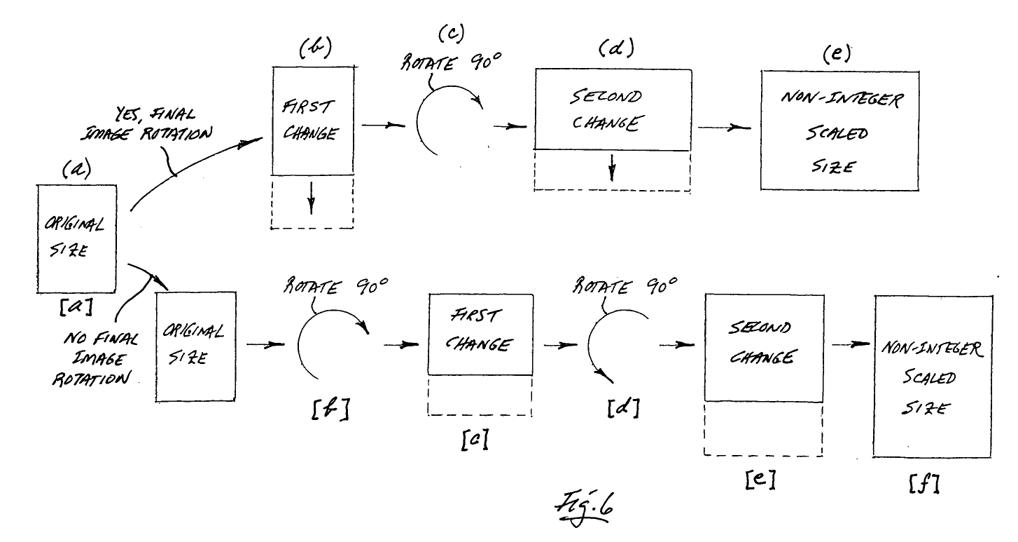

A thoughtful review, now, of FIGS. 5 and 6, given the descriptions presented above for FIGS. 1-4, inclusive, should quickly inform those skilled in the art how to practice the selectability approach which is offered by the embodiment of the invention illustrated in FIGS. 5 and 6. Specifically, the embodiment of the invention which is illustrated in FIGS. 5 and 6 effectively offers a user of the invention selectability as to which of two different processing non-integer scaling routes of a bi-tonal image that the user wishes to follow. One route implements the practice illustrated in FIGS. 1 and 2, and the other route implements the practice illustrated in FIGS. 3 and 4. To accomplish this, the embodiment of the invention illustrated in FIGS. 5 and 6 offers an initial route selection block which asks the question whether the user wishes to have the final output, scaled, bi-tonal image rotated by 90-degrees or not. If the answer to that question is Yes, then the route which is followed is illustrated in the upper portion FIG. 6, and one will see that this route, that is the route beyond the question block regarding rotation, implements the processing practice of FIGS. 1 and 2. If the answer to the rotation question is No, then the route of processing which is followed is illustrated along the lower side of FIG. 6, which route can be seen to be essentially the same route pictured with respect to FIGS. 3 and 4.

The invention is thus described now in several preferred and best mode embodiments and manners of practice. Accordingly, and while this invention has so been presented, it is appreciated that variations and modifications may be made without departing from its spirit.

1. A method for the non-integer scaling of bi-tonal image files comprising
selecting a bi-tonal image file for non-integer scaling by a selected scaling factor, and
with respect to that selected image file, applying scaling processing in a manner which includes a pair of line-by-line, one-dimensional image expansions, each employing the selected scaling factor, with these two image expansions being separated by one step involving orthogonal rotation of the image file.

2. A method for scaling a bi-tonal image file by a non-integer scaling factor to produce, from a selected source image, an orthogonally rotated. scaled bi-tonal output image comprising
selecting a bi-tonal image for non-integer scaling processing,
performing a first, one-dimensional, line-by-line, lateral image expansion applying the selected scaling factor,
orthogonally rotating the image data file resulting from this first expansion step, and
following said rotating, performing a second, one-dimensional, line-by-line lateral image expansion also by applying the selected scaling factor, thus to produce the desired, orthogonally rotated, non-imager-scaled bi-tonal output image.

3. A method for scaling a selected bi-tonal image file by a selected scaling factor to produce a scaled, non-rotated, bi-tonal output image comprising
selecting a bi-tonal image for non-integer scaling processing,
performing in one direction one orthogonal rotation of the selected image file,
with respect to that rotated image file, performing a first one-dimensional, row-by-row lateral image-file expansion employing the selected non-integer scaling factor,
performing thereafter a second orthogonal rotation with respect to that first, one-dimensional expanded image file, with this rotation taking place in the opposite direction of rotation relative to the first described image-file rotation, and
then performing a second one-dimensional, line-by-line image file expansion utilizing the selected scaling factor, thus to produce the desired output non-rotated non-integer scaled bi-tonal image.

4. A method for non-integer scaling of a selected-bi-tonal image file by a selected scaling factor, with selectability offered with respect to whether the processed output bi-tonal image is to be rotated or non-rotated relative to its starting orientation comprising
selecting a bi-tonal image file for non-integer scaling by a selected scaling factor,
offering a choice of whether or not a final scaled bi-tonal output image is to be rotated or not with respect to its initial rotational orientation, and
if selection is made to produce a rotated output image, then applying to the selected image file a pair of orthogonally related, one-dimensional, line-by-line image expansions employing the selected scaling factor, and intermediate these two image expansion steps performing a single orthogonal rotation of the image file, and if the selection is to produce a non-rotated output image, employing a pair of one-dimensional line-by-line image file lateral expansions utilizing the selected scaling factor, interleaved with a pair of orthogonal, counter rotations of the image file.
